(19) United States
(12) Patent Application Publication
(10) Pub. No.: US 2025/0137394 A1
(43) Pub. Date: May 1, 2025

(54) ELECTRIC HEATING DEVICE FOR HEATING AN EXHAUST GAS STREAM

(71) Applicant: Faurecia Emissions Control Technologies, Germany GmbH, Augsburg (DE)

(72) Inventor: David SAURAT, Augsburg (DE)

(21) Appl. No.: 18/907,726

(22) Filed: Oct. 7, 2024

(30) Foreign Application Priority Data
Oct. 31, 2023 (DE) 10 2023 210 825.9

(51) Int. Cl. F01N 3/20; B01D 53/94

(52) U.S. Cl. CPC F01N 3/2013; B01D 53/94

(57) ABSTRACT

An electric heating device for heating an exhaust gas stream may have a housing, an electric heating element and at least one support rod connected to the heating element and having two opposite ends arranged on the housing. The electric heating element and support rod may be accommodated in the housing. The support rod may be movably arranged on at least one of its ends in a sliding bearing to compensate for a thermally induced change in shape of the support rod. The sliding bearing may be fixedly connected to the housing. The heating device may be provided for use in an exhaust system such as in a motor vehicle, which in particular can handle mass flow rates of more than 600 kg/h.

### FIELD

The present application relates to an electric heating device for heating an exhaust gas stream. The heating device can be provided for use in an exhaust system, e.g. the exhaust system of a motor vehicle, which in particular must be able to handle mass flow rates of more than 600 kg/h.

### BACKGROUND

Corresponding exhaust systems can be used in motor vehicles with combustion engines to clean the exhaust gas stream emitted by the engine into the environment, and are known as automotive catalytic converters. For this purpose, the exhaust gas stream to be cleaned must be brought to a working temperature, for which a heating device arranged in the exhaust system is usually used. The heating device can be an electrical heating device, i.e. a heating device in which, by applying an electrical voltage to an electrically conductive heating element, the heating element converts the electrical energy into heat and releases it, for example, to an exhaust gas flowing around and/or through the heating element.

A particular challenge in the design of heating devices for heating an exhaust gas stream is that, on the one hand, they must transfer heat to the exhaust gas stream particularly efficiently and, on the other hand, they must withstand mechanical stresses, such as thermal expansion, vehicle vibrations and/or the flow pressure of the exhaust gas stream, in particular at high mass flow rates.

### SUMMARY

The present invention is based on the object of proposing an alternative and/or improved electric heating device, wherein the improvement lies in particular in addressing at least one of the aforementioned challenges.

According to the invention, this object is achieved by an electric heating device having the features of the main claim. Possible embodiments and developments can be found in the dependent claims and the following description.

The proposed electric heating device for heating an exhaust gas stream comprises a housing, an electric heating element and at least one support rod connected to the heating element and having two opposite ends arranged on the housing, which electric heating element and support rod are accommodated in the housing. The support rod is movably arranged on at least one of its ends in a sliding bearing to compensate for a thermally induced change in the shape of the support rod, wherein the sliding bearing is fixedly connected to the housing.

By arranging the support rod and sliding bearing in the housing, it is possible to provide thermally compensating support of the heating element so that the heating element is supported particularly efficiently and the exhaust gas stream and its heating are disturbed as little as possible. During operation, the heating device is usually subject to thermally induced deformations, in particular of the heating element and the support rod connected to the heating element. In particular, the arrangement of the support rod and the sliding bearing can compensate for thermally induced expansion, contraction or any other movement of the support rod, in particular in its longitudinal direction, because an upper surface of the support rod and an inner surface of the sliding bearing, which is fixedly connected to the housing and rests on the surface of the support rod, for example, can be displaced relative to one another. This can reduce unwanted thermally induced movement of the heating element in the housing.

In the housing, the exhaust gas stream can be guided from an inlet, in particular a housing inlet, to an outlet, in particular a housing outlet. An axial direction in which the exhaust gas stream flows through the housing can be defined between the inlet and outlet.

The support rod can be movably arranged at both of its ends in a sliding bearing to compensate for a thermally induced change in shape of the support rod, wherein both sliding bearings are fixedly connected to the housing. The sliding bearings can be constructed and arranged identically. Due to the sliding bearings arranged at both ends of the support rod, a thermally induced change in shape of the support rod can be compensated for more evenly so that distortion of the heating element in the housing can be minimized.

The support rod can extend transversely and in particular orthogonally to an axial direction of the housing in which the exhaust gas stream flows through the housing. The support rod can extend between two opposite sides of the housing and in particular through the housing. The support rod can be arranged parallel to the heating element. The support rod can be arranged in front of or behind the heating element in the direction of the exhaust gas stream—i.e. downstream. In particular, the arrangement thereof downstream of the heating element can be advantageous because it reduces the heat outflow of the exhaust gas that has not yet passed through the heating element and is therefore relatively cold, and increases the durability and stability of the heating device. The support rod can have a round, in particular circular, or rectangular cross section, in particular having two long and two short sides, wherein the long sides can extend along the axial direction of the housing. The support rod can be straight, in particular continuously straight, or curved. In this case, the curvature can be concave relative to the housing, i.e. the support rod can be curved in a direction orthogonal to the exhaust gas stream toward the center of the housing. Such a curvature can, for example, improve the mechanical stability of the support rod and heating element. The curvature should be selected in such a way that the support rod can be moved easily, in particular without jamming, in the sliding bearing.

In principle, a plurality of, i.e. at least two and/or a maximum of six or a maximum of four, in particular identically constructed, support rods can be provided. The number, shape and/or dimensioning of the support rods can be selected such that a sufficient support structure is formed for the heating element, e.g. one that is mechanically resistant to the mass flow rate of the exhaust gas, and at the same time the heating element is shielded as little as possible from the exhaust gas stream, as is the case, for example, for a support rod having a circular or rectangular cross section having two long sides running in the axial direction and two short sides orthogonal thereto. If a plurality of support rods are provided, they should be spaced apart from each other in such a way that a direct flow of current between the support rods, even due to arcing, is not possible. The support rods can also be arranged parallel to each other and/or at the same distance from the heating element.

The support rod can be electrically and/or thermally insulated from the housing, in particular by means of the sliding bearing. This can prevent unwanted current leakage (bypass) or heat loss. In particular, the heating element can be heated in a targeted and efficient manner.

The support rod can be arranged in the sliding bearing by means of a clamp, wherein a resulting clamping force exerted on the support rod by the clamp is configured to prevent unwanted displacement and/or shaking of the support rod in the sliding bearing when the electric heating device is used as intended, e.g. when the heating device is installed as part of an exhaust system in a vehicle. In other words, the support rod can be connected to the sliding bearing with a non-positive connection. The clamping force and/or the non-positive connection can be selected in such a way that, on the one hand, a thermally induced relative movement between the support rod and the sliding element is possible and, on the other hand, shaking or unintentional displacement of the support rod as a whole is avoided.

The sliding bearing can comprise an outer casing that surrounds the support rod, in particular completely circumferentially. The support rod can therefore be received at its corresponding end in a recess of the sliding bearing that is defined by the outer casing. The recess and the support rod can be arranged in alignment with one another. In other words, the recess can extend in the same direction as the support rod received therein and thereby form a sliding seat receptacle for the support rod, so that the most uniform compensation possible can be provided without wedging the support rod and the sliding bearing. The outer casing can comprise or consist of two opposite casing halves. The two casing halves make it particularly easy to adjust the required clamping force. The sliding bearing can comprise an electrically and/or thermally insulating layer arranged between the outer casing and the support rod. For example, the insulating layer can electrically and/or thermally insulate the support rod from the housing. The insulating layer can be elastic, which makes it easier to adjust the required clamping force, for example. The insulating layer can comprise or consist of a needle-like polycrystalline fiber mat, a ceramic—in particular, aluminum oxide-ceramic-material, and/or a glass fiber-reinforced ceramic composite material. Optionally, one of the two casing halves can at least partially overlap the other casing half in the circumferential direction of the support rod. This can be advantageous in particular in combination with a support rod having a circular cross section because this makes it easier to adjust the compression of the insulating layer, in particular an elastic insulating layer. On the other hand, the desired clamping force can also be adjusted by the choice of the thickness of the insulating layer. Overlapping of the casing halves is then not necessary. The insulating layer can be arranged directly adjacent to the support rod and/or the outer casing.

The support rod can be connected to the heating element at a single contact point. This can prevent unwanted current leakage. The support rod can be fixed to, and in particular materially bonded to, the heating element. The connection should be as thermally resistant as possible when the heating device is used as intended. The connection can be a welded connection and in particular a laser-welded connection. The support rod can be made of metal or comprise a metal. The metal can in particular be or comprise a high-alloy stainless steel, such as 1.4301, or a NiCr alloy. These materials are particularly temperature-resistant and can withstand high mechanical stress.

The support rod can be spaced from the heating element. This makes it possible to minimize shielding of the heating element from the exhaust gas stream by the support rod on the one hand and excessive heating of the support rod by the heating element on the other hand. This can also prevent arcing between the support rod and the heating element, for example at very high operating voltages. The distance can be a maximum of 10 mm, 5 mm or 3 mm and a minimum of 0.5 mm or 1 mm. The support rod can have a projection extending in the direction of the heating element, at the end of which the support rod is connected to the heating element. Thus, the support rod can simultaneously be spaced from the heating element and only connected to the heating element in the region of the projection. The projection should therefore be as limited as possible in its dimension in the longitudinal direction of the support rod and should not, for example, be more than 1/10, 1/20 or 1/40 of the length of the support rod measured between the two ends.

The heating element can comprise a heater grid having current-carrying grid elements that have a minimum thickness of not more than 5 mm, 3 mm or 1 mm and not less than 0.5 mm, 0.3 mm or 0.1 mm. Such a heater grid allows the exhaust gas stream to be heated particularly efficiently. At the same time, the heater grid is a relatively delicate structure, for which a support structure having a support rod and a sliding element as disclosed herein can be particularly advantageous. The heater grid can be designed in the form of a disk, in particular a circular disk, that is arranged concentrically with the housing. In particular, the disk can extend in a radial plane transversely and in particular orthogonally to the axial direction. The heating element can further comprise a support ring arranged between the support rod and the heater grid. The support ring can be circular. The support ring can be arranged coaxially and/or parallel to the heater grid. The support ring can be fixedly and in particular materially connected to the heater grid. The heater grid and the support ring can be designed as one piece and in particular as a monolith, i.e., for example, made from a single workpiece. The support rod can be fixedly and in particular materially connected to the support ring, e.g. by means of a welded connection and in particular by means of a laser-welded connection. The support ring can provide the required connection between the support rod and the heating element, in particular between the support rod and the heater grid. The support ring can comprise a plurality of legs, each formed as a projection. In this case, the legs can act as thermal compensators that minimize thermally induced mechanical stress on the support ring and components connected thereto. The legs can extend in a radial plane of the support ring.

The electric heating device can comprise two, in particular exactly two, support rods. The support ring can then be arranged between the two support rods and in particular connected thereto, optionally at a distance that corresponds to a diameter of the support ring. In other words, the two support rods can be connected to the support ring at two diametrically opposite contact points. This allows for particularly uniform compensation.

As an alternative to an embodiment of the heating element having a heater grid, the heating element can be and/or comprise, for example, a heating foam made of current-carrying foam material of a predetermined density. A corresponding heating element is described, for example, in document DE 10 2021 006 655 A1. The heating foam is heated by applying an electrical voltage and can be flowed through by the exhaust gas stream. Such a heating foam allows the exhaust gas stream to be heated particularly efficiently. At the same time, the heating foam is a relatively delicate structure, for which a support structure having a support rod and a sliding element as disclosed herein can be particularly advantageous. In a connection region in which the support rod is connected to the heating element, the heating element can have a region of increased density. This can increase the stability of the connection, in particular a material connection, between the support rod and the heating element. The increased density can be at least 2 or 3 times and at most 4, 6 or 10 times the predetermined density of the remaining foam material. The densities depend in particular on the required heating output and stability of the heating device. The connection region can be arranged centrally in the heating element, in particular in a plane orthogonal to the exhaust gas stream. This is usually the region of the heating element that is subject to the greatest mechanical requirements in the heating device.

The heating foam can be divided by interruptions into portions, which, when viewed in a cross section, lie next to one another in such a way that a current path is predefined that extends from a current entry point of the heating element to a current exit point, for example from one side of the heating element to the other side. The portions can therefore be elongated portions that extend, for example, transversely and in particular orthogonally to the exhaust gas stream. In the case of a heating element designed as a circular disk, for example, the length of the portions increases toward the center of the disk, while their mechanical stability decreases at the same time. It can be advantageous to use the support rod(s) to support those portions of the heating element that have a lower mechanical stability. The heating foam can, for example, be divided into at least five or N≥5 portions and the number of support rods can correspond to N−4. In other words, two support rods can be provided for six portions and four support rods for eight portions. In this case, the support rods can be connected to portions that have the lowest mechanical stability, in particular depending on the geometry of the heating element. The number of portions can be a maximum of ten or a maximum of eight, wherein a consideration can also be made depending on the heating output and stability of the heating device as well as the avoidance of hot spot formation. Alternatively, only three or four portions and one or two support rods may be provided.

The heating device can be designed for a maximum mass flow rate of the exhaust gas of at least 600 kg/h and a maximum operating temperature of at least 920° C.

The support structure described here comprising a support rod and a sliding element can be used particularly advantageously with a heating element that comprises a heater grid or is designed as a heating foam, but is of course not limited thereto. In principle, the heating device can also comprise common electric heating elements.

In the present case, several embodiments have been disclosed. Further embodiments and advantageous combinations of individual features of the present invention will become apparent to a person skilled in the art from the following detailed description, which shows and describes three embodiments of the invention given by way of example. Accordingly, the drawings and the detailed description are to be regarded as illustrative and not limiting. Recurring features are provided with the same reference signs in the figures.

### DESCRIPTION OF THE FIGURES

FIG. 1 is a schematic sectional view of a first embodiment of an electric heating device according to the invention,

FIG. 2 is a schematic representation of the embodiment of FIG. 1 in a sectional plane orthogonal to the sectional view of FIG. 1,

FIG. 3 is a schematic detailed view of an exemplary support rod in a sectional view through a sliding bearing,

FIG. 4 is a schematic detailed view of another exemplary support rod in a sectional view through a sliding bearing,

FIG. 5 is a schematic sectional view of a second embodiment of an electric heating device according to the invention,

FIG. 6 is a schematic representation of the embodiment of FIG. 5 in a sectional plane orthogonal to the sectional view of FIG. 5,

FIG. 7 is a schematic detailed view of a connection between the support rod and the heating element of the heating device of FIG. 5 and

FIG. 8 is a schematic sectional view of a third embodiment of an electric heating device according to the invention.

### DETAILED DESCRIPTION

In the following, recurring features are described once for all figures. References to specific figures are made only where appropriate.

The proposed electric heating device 1 for heating an exhaust gas stream comprises a housing 10, an electric heating element 100; 200 and at least one support rod 20 connected to the heating element 100; 200 and having two opposite ends arranged on the housing 10, which electric heating element and support rod are accommodated in the housing 10. The support rod 20 is movably arranged on at least one of its ends in a sliding bearing 30 to compensate for a thermally induced change in shape of the support rod 20, wherein the sliding bearing 30 is fixedly connected to the housing 10.

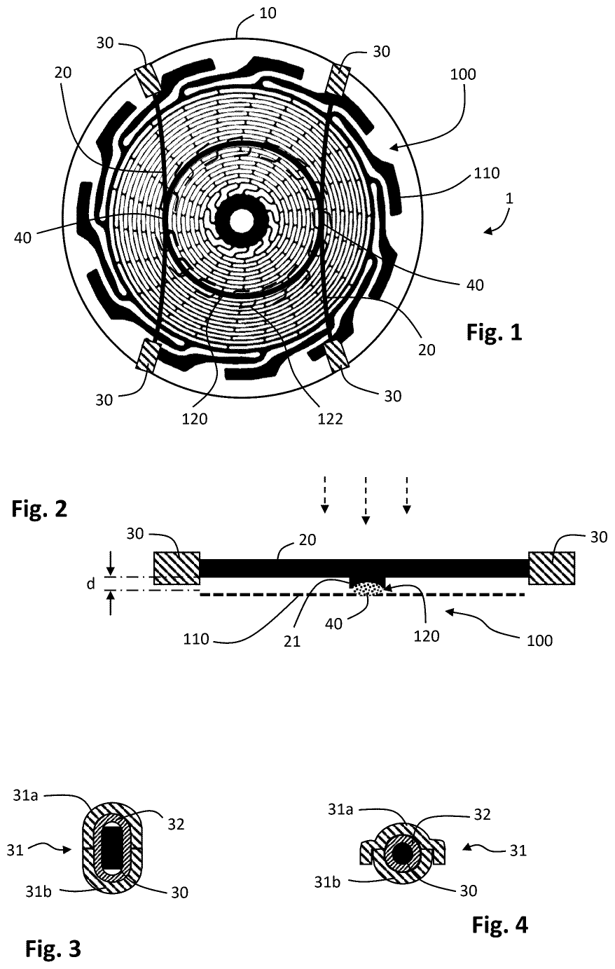

In the housing 10, the exhaust gas stream can be guided from an inlet, in particular a housing inlet, to an outlet, in particular a housing outlet. An axial direction in which the exhaust gas stream flows through the housing 10 can be defined between the inlet and outlet. According to the exemplary representations of FIGS. 1, 5 and 8, a corresponding exhaust gas stream would move into the sheet plane and according to the representations of FIGS. 2, 3, 4, 6 and 7 along the sheet planes, as indicated in FIGS. 2 and 6 by dashed arrows.

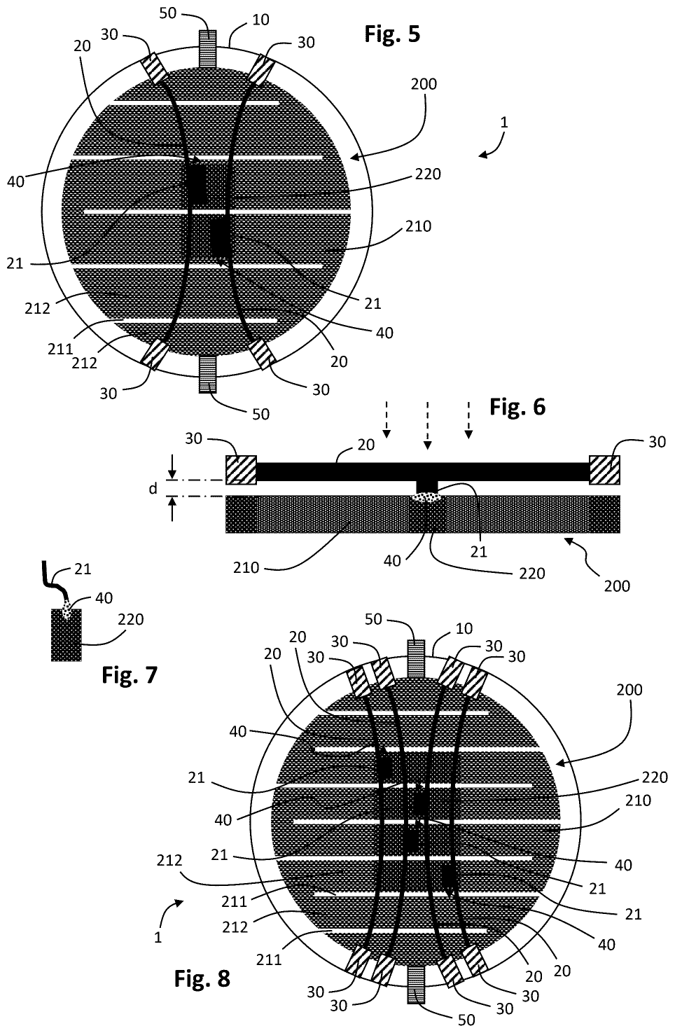

In principle, a plurality of, i.e. at least two and/or a maximum of six or a maximum of four, in particular identically constructed, support rods 20 can be provided. Thus, in the exemplary embodiments according to FIGS. 1 and 5, two and, according to the embodiment of FIG. 8, four substantially identical support rods 20 are provided, which is why the following description always refers to a plurality of support rods 20. The support rods 20 are each spaced apart from one another and arranged substantially parallel to one another and at the same distance from the heating element 10.

In the present case, each of the support rods 20 is movably arranged at both of its ends in a sliding bearing 30 to compensate for a thermally induced change in shape of the support rod 20, wherein both sliding bearings 30 are fixedly connected to the housing 10. The sliding bearings 30 are constructed and arranged identically. The following description therefore always refers to a plurality of sliding bearings 30.

Each of the support rods 20 extends transversely, in this case orthogonally, to the axial direction of the housing 10 in which the exhaust gas stream flows through the housing 10. Each of the support rods 20 extends between two opposite sides of the housing 10 and through the housing 10. Each of the support rods 20 is arranged parallel to the heating element 100; 200. In the present case, the support rods 20 are arranged, in front of the heating element 10 in the direction of the exhaust gas stream, i.e. downstream. In principle, however, they can also be arranged after it. The support rods 20 can have a round, in particular circular (as shown in FIG. 4), or rectangular cross section, in particular having two long and two short sides (as shown in FIG. 3), wherein the long sides extend along the axial direction of the housing 10. The support rods 20 can be straight, in particular continuously straight, or curved. In this case, all of the support rods 20 are curved. In this case, the curvature is concave relative to the housing 10, i.e. the support rods 20 are curved in a direction orthogonal to the exhaust gas stream toward the center of the housing 10.

Each of the support rods 20 is arranged in the respective sliding bearing 30 at both of its ends by means of a clamp, wherein a resulting clamping force exerted on the support rods 20 by the clamps is configured to prevent unwanted displacement and/or shaking of the support rods 20 in the sliding bearings 30 when the electric heating device 1 is used as intended, e.g. when the heating device 1 is installed as part of an exhaust system in a vehicle. In other words, the support rods 20 are connected to the sliding bearings 30 with a non-positive connection. Each of the sliding bearings 30 comprises an outer casing 31 that completely circumferentially surrounds the particular support rod 20. The particular support rod 20 is thus received at its corresponding end in a recess of the corresponding sliding bearing 30, which is defined by the outer casing 31, as can be seen in particular from FIGS. 3 and 4. In this case, the recess and the support rod 30 are arranged in alignment with one another. In other words, the recess extends in the same direction as the support rod 20 received therein and thereby forms a sliding seat receptacle for the particular support rod 30. The outer casing 31 comprises two opposite casing halves 31a, 31b. Each of the sliding bearings 30 comprises an electrically and thermally insulating layer 32 arranged between the outer casing 31 and the support rod 30. Thus, in the present case, the support rods 20 are electrically and thermally insulated from the housing 10 at least by means of the sliding bearings 30. The insulating layer 32 can be elastic, which makes it easier to adjust a required clamping force, for example. The insulating layer 32 can comprise or consist of a needle-like polycrystalline fiber mat, a ceramic, in particular aluminum oxide-ceramic, material and/or a glass fiber-reinforced ceramic composite material. According to the example of FIG. 4, one of the two casing halves 31a partially overlaps the other casing half 31b in the circumferential direction of the support rod 30. The insulating layer 32 is arranged directly adjacent to the support rod 20 and the outer casing 31. If appropriate, further insulating intermediate layers can also be provided, which are, for example, electrically and/or thermally insulating layers.

Each of the support rods 20 is connected to the heating element 100; 200 at a single contact point, which may also be referred to as connection 40 in the present case. Each of the support rods is fixedly and materially connected to the heating element 100; 200. The connection 40 can be a welded connection and in particular a laser-welded connection, as indicated in FIGS. 2, 6 and 7. The support rods 20 can be made of metal or comprise a metal. The metal can in particular be or comprise a high-alloy stainless steel, such as 1.4301, or a NiCr alloy. These materials are particularly temperature-resistant and can withstand high mechanical stress.

Each of the support rods is spaced from the heating element 100; 200. The distance d can be a maximum of 10 mm, 5 mm or 3 mm and a minimum of 0.5 mm or 1 mm. Each of the support rods 20 has a projection 21 extending in the direction of the heating element 100; 200, at the end of which the particular support rod 20 is connected to the heating element 100; 200. The projections 21 are limited in their dimensions in the longitudinal direction of each of the support rods 20, and are, for example, not more than 1/10, 1/20 or 1/40 of a length of the respective support rods 20 measured between the two ends.

According to the exemplary embodiment of FIG. 1, the heating element 100 comprises a heater grid 110 having current-carrying grid elements. Electrodes for applying an electrical voltage required for the heating process to the heating element 100 are not shown here. The grid elements can have a minimum thickness of not more than 5 mm, 3 mm or 1 mm and not less than 0.5 mm, 0.3 mm or 0.1 mm. The heater grid 110 is designed in the form of a circular disk that is arranged concentrically with the housing 10. The heater grid 110 extends in a radial plane orthogonal to the axial direction. A minimum thickness or dimension can be, for example, 1 mm in the axial direction and 0.1 mm in a radial direction. The heating element 100 further comprises a support ring 120 arranged between each of the support rods 20 and the heater grid 110. The support ring 120 is circular and arranged parallel to the heater grid 110. The support ring 120 is fixedly and materially connected to the heater grid 110. The heater grid 110 and the support ring 120 can be designed as one piece and in particular as a monolith, i.e., for example, made from a single workpiece. Each of the support rods 20 is fixedly and materially connected to the support ring 120, e.g. by means of a welded connection and in particular by means of a laser-welded connection. For example, in the present case the support rod 30 shown in FIG. 2 is connected to the heater grid 110 via the support ring 120. The support ring 120 comprises a plurality of legs 122, each formed as a projection. The legs 122 extend in a step-like manner in a radial plane of the support ring 120. The electric heating device 1 according to FIG. 1 comprises exactly two support rods 20. The support ring 120 is arranged between the two support rods 20 and connected thereto at a distance that corresponds to a diameter of the support ring 120. In other words, the two support rods 20 are connected to the support ring 120 at two diametrically opposite contact points or connections 40.

As an alternative to the embodiment of the heating element 100 having a heater grid 110, the heating element 200 can be, for example, or comprise a heating foam 210 made of current-carrying foam material of a predetermined density, as shown in FIGS. 5 to 8. The heating foam 210 is heated by applying an electrical voltage and can be flowed through by the exhaust gas stream. In the present two examples, the required heating voltage is provided by two opposite electrodes 50. In a connection region in which the support rods 20 are connected to the heating element 200, the heating element 200 has a region of increased density 220. The increased density can be at least 2 or 3 times and at most 4, 6 or 10 times the predetermined density of the remaining foam material. The connection region or region of increased density 220 is centrally located in the heating element 200 in a plane orthogonal to the exhaust gas stream, as shown in FIGS. 5 and 8. Additional regions of increased foam density can be provided on the outer circumference of the heating element 200, as indicated in FIG. 6. However, these primarily serve to improve current conduction, as explained in more detail in the above-mentioned document DE 10 2021 006 655 A1. In the present case, the heating foam 210 is divided by interruptions 211 into portions 212, which, when viewed in a cross section, lie next to one another in such a way that a current path is predefined that extends from a current entry point or first electrode 50 of the heating element to a current exit point or second electrode 50, in this case from one side of the heating element 200 to the other side. The portions 212 are elongated portions 212 that extend orthogonally to the exhaust gas stream. Because the heating element 200 is circular in the present case, the length of the portions 212 increases toward the center of the disk, while their mechanical stability generally decreases at the same time. The support rods 20 support precisely those portions of the heating element 20 that have a lower mechanical stability. In order to support the respective portions 212 as much as possible in regions of lower mechanical stability, the projections 21 of the respective support rods 20 are formed in a step-like manner toward the center of the portions 212, as shown in FIG. 7. The heating foam can, for example, be divided into at least five or N≥5 portions and the number of support rods can correspond to N−4. In other words, as shown in FIG. 5, two support rods 20 are provided for six portions 212 and, as shown in FIG. 8, four support rods 20 are provided for eight portions 212. The support rods 20 are connected to portions 212 that have the lowest mechanical stability, i.e. are in this case arranged centrally in the housing 10. The number of portions 212 can be a maximum of ten or a maximum of eight. Alternatively, only three or four portions 212 and correspondingly one or two support rods 20 may be provided.

The heating device 1 can be designed for a maximum mass flow rate of the exhaust gas of at least 600 kg/h and a maximum operating temperature of at least 920° C.

What is claimed is:

1. An electric heating device for heating an exhaust gas stream, comprising:
a housing,
an electric heating element and at least one support rod connected to the heating element and having two opposite ends arranged on the housing, wherein the electric heating element and support rod are accommodated in the housing, wherein
the support rod is movably arranged on at least one of its ends in a sliding bearing to compensate for a thermally induced change in shape of the support rod, wherein the sliding bearing is fixedly connected to the housing.

2. The electric heating device according to claim 1, wherein the support rod is movably arranged at both of its ends in a sliding bearing to compensate for a thermally induced change in shape of the support rod, wherein the sliding bearings are fixedly connected to the housing.

3. The electric heating device according to claim 1, wherein the support rod extends orthogonally to an axial direction of the housing in which the exhaust gas stream flows through the housing.

4. The electric heating device according to claim 1, wherein the support rod is electrically and/or thermally insulated from the housing.

5. The electric heating device according to claim 1, wherein the support rod is arranged in the sliding bearing by a clamp, wherein a resulting clamping force exerted on the support rod by the clamp is configured to prevent unwanted displacement and/or shaking of the support rod in the sliding bearing when the electric heating device is used.

6. The electric heating device according to claim 1, wherein the sliding bearing comprises an outer casing surrounding the support rod, and an electrically and/or thermally insulating layer is arranged between the outer casing and the support rod.

7. The electric heating device according to claim 6, wherein the insulating layer comprises a needle-like polycrystalline fiber mat, an aluminum oxide-ceramic material, and/or a glass fiber-reinforced ceramic composite material.

8. The electric heating device according to claim 1, wherein the sliding bearing comprises an outer casing made of two opposing casing halves.

9. The electric heating device according to claim 1, wherein the support rod is connected to the heating element at a single contact point and/or is fixedly connected.

10. The electric heating device according to claim 1, wherein the support rod is spaced from the heating element and the distance between the support rod and the heating element is at most 10 mm and at least 0.5 mm.

11. The electric heating device according to claim 10, wherein the support rod is spaced from the heating element and the distance between the support rod and the heating element is at most 3 mm and at least 1 mm.

12. The electric heating device according to claim 1, wherein the support rod has a projection extending in the direction of the heating element, at the end of which projection the support rod is connected to the heating element.

13. The electric heating device according to claim 1, wherein the heating element comprises a heater grid having current-carrying grid elements that have a minimum thickness of not more than 5 mm and not less than 0.1 mm, and the heating element further comprises a support ring that is arranged between the support rod and the heater grid, wherein the support ring is connected to the heater grid and/or the support rod is fixedly connected to the support ring, and/or the support ring comprises a plurality of legs that are in each case designed as a projection.

14. The electric heating device according to claim 1, wherein the heating element comprises a heater grid having current-carrying grid elements that have a minimum thickness of not more than 1 mm and not less than 0.5 mm.

15. The electric heating device according to claim 13, wherein the electric heating device comprises two support rods and the support ring is arranged between the two support rods.

16. The electric heating device according to claim 15, wherein the support ring is connected to the support rods at a distance corresponding to a diameter of the support ring.

17. The electric heating device according to claim 1, wherein the heating element is a heating foam made of current-carrying foam material of a predetermined density, and has a region of increased density in a connection region in which the support rod is connected to the heating element.

18. The electric heating device according to claim 17, wherein the heating foam is divided by interruptions into portions, which, when viewed in a cross section, lie next to one another in such a way that a current path is predefined that extends from a current entry point of the heating element to a current exit point.

19. The electric heating device according to claim 18, wherein the heating foam is divided into N≥5 portions and the number of support rods corresponds to N−4.

20. The electric heating device according to claim 1, wherein the support rod has a circular or rectangular cross section having two long and two short sides, wherein the long sides extend along an axial direction of the housing in which the exhaust gas stream flows through the housing.

21. The electric heating device according to claim 1, wherein the heating device is designed for a maximum mass flow rate of the exhaust gas of at least 600 kg/h and a maximum operating temperature of at least 920° C.
